(19) United States
(12) Patent Application Publication
(10) Pub. No.: US 2013/0132020 A1
(43) Pub. Date: May 23, 2013

(54) METHOD AND FACILITY, USING TRANSFER BETWEEN A GAS AND A LIQUID, FOR PREDETERMINING AT LEAST ONE CONVERSION PARAMETER

(71) Applicants: Pierre Guillot, Pessac (FR); Roman Koetitz, Bordeaux (FR); Matthieu Guirardel, Bordeaux (FR)

(72) Inventors: Pierre Guillot, Pessac (FR); Roman Koetitz, Bordeaux (FR); Matthieu Guirardel, Bordeaux (FR)

(73) Assignee: Rhodia Operations, Aubervilliers (FR)

(21) Appl. No.: 13/515,219

(22) PCT Filed: Dec. 9, 2010
(86) PCT No.: PCT/FR2010/052657

§ 371 Date: Jan. 24, 2013

(30) Foreign Application Priority Data
Dec. 9, 2009 (FR) 0958789

(51) Int. Cl. G01N 7/14; G06F 17/10

(52) U.S. Cl. CPC G01N 7/14; G06F 17/10
USPC 702/100; 73/19.1

(57) ABSTRACT

Said method for predetermining at least one conversion parameter uses at least one transfer between a liquid phase and a gas phase, wherein: a gas phase is injected into a liquid phase so as to form a heterogeneous flow including a series of bubbles, formed from the gas phase, within the liquid phase; said heterogeneous flow is caused to occur within a flow member so as to carry out at least one transfer between the liquid and gas phases; the decrease in the volume of the bubbles is observed along said flow member; and said at least one parameter is derived therefrom.

The present invention relates to a method and facility, using a transfer between the gas and liquid phases, for predetermining at least one physical and/or chemical conversion parameter.

Within the meaning of the invention, “conversion” refers to any type of interaction of a nature to involve at least one transfer between a liquid phase and a gas phase. However, such a transfer between these two phases can also be accompanied by an additional phenomenon.

Non-limitingly, a conversion within the meaning of the invention can also involve a chemical and/or physical reaction, for example such as any type of traditional chemical reaction, as well as crystallization or precipitation. Generally, within the meaning of the invention, such a conversion may involve chemical phenomena, by combining or exchanging electrons, physical interactions or repulsions, such as hydrogenous bonds, electrostatic interactions, stearic attractions or repulsions, affinities of different hydrophilic and/or hydrophobic mediums, formulation stabilities, or breakings.

Within the meaning of the invention, a system able to undergo such a conversion, using at least one transfer between the gas and liquid phases, is called a physicochemical system.

Within the meaning of the invention, the parameters of such a conversion, which one wishes to access, are in particular thermodynamic or kinetic. Thermodynamic parameters thus relate to the state of equilibrium between the liquid and gas phases, once the latter have been put in contact. In that case, the solubility limit, the Henry's coefficient, the saturated steam pressure of the liquid, the diffusion coefficient of the gas in the liquid, or the vaporization latent heat of that liquid are involved.

On the other hand, kinetic parameters relate to the transitional phase, which occurs immediately after said liquid and steam phases are put in contact, but precedes the aforementioned equilibrium phase. In the latter case, these parameters are for example the mass transfer coefficient, or relate to the chemical kinetics of the conversion. In the latter case, this may for example involve advancing said conversion.

Different solutions are known that aim to determine at least one parameter, as presented above. Typically, the method of the state of the art use sensors. However, these involve certain drawbacks, inasmuch as they are not easily applicable on a small scale. Furthermore, these methods generally use destructive techniques.

Known from the article “Bubble growth with chemical reactions in microchannels” by Fu B. R. et al (International Journal of Heat and Mass Transfer 52, pages 767 to 779) is a method for observing gas bubble growth in a liquid phase. More specifically, this article is interested in the nucleation and growth of CO₂ bubbles produced by the reaction between two miscible liquids, NaHCO₃ and H₂SO₄. In other words, it is therefore proposed to study a reaction between liquid reagents in homogenous phase, which produces a heterogeneous gas phase, by monitoring the product of the reaction. This is remote from the field of the present invention, which is interested in gas-liquid systems that are initially heterogeneous and then evolve through a transfer between the liquid and gas phases, typically by solubilizing.

That being specified, the invention aims to implement a method which, while allowing reliable access to at least one parameter of a conversion using a liquid-gas transfer, can be implemented relatively simply and quickly. It also relates to the implementation of such a method, which is satisfactory in terms of security and economically, both relative to the equipment used and the quantity of liquid and gas components used.

To that end, it relates to a method, using a transfer between a liquid phase and a gas phase, for predetermining at least one conversion parameter, as defined in claim 1.

Additional advantageous features of this method, considered alone or according to all technically possible combinations, are specified in dependent claims 2 to 23.

The invention also relates to a facility for implementing the method defined above, as defined in claim 24.

The invention will be described below in reference to the appended drawings, which are provided solely as non-limiting examples, and in which:

FIG. 1 is a diagrammatic view, illustrating a predetermination facility according to the invention;

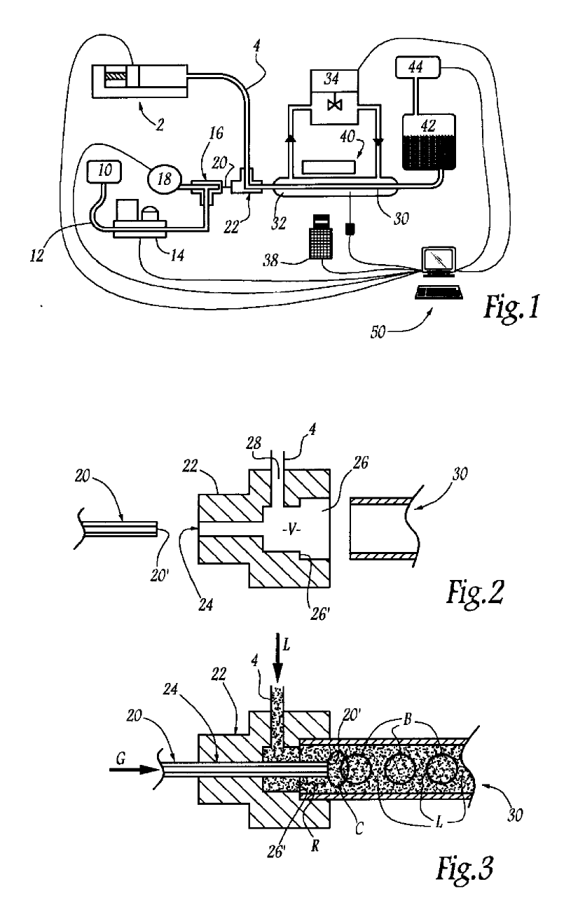

FIGS. 2 and 3 are larger-scale longitudinal cross-sectional views illustrating bubble-forming means belonging to said facility;

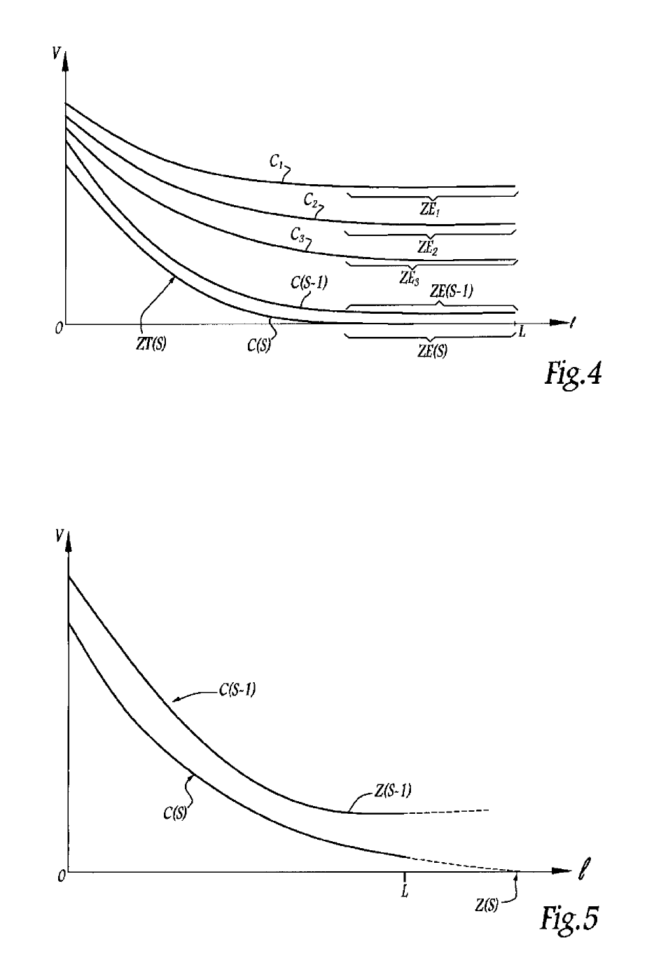

FIGS. 4 and 5 are graphs, illustrating the bubble volume as a function of the position of said bubbles, during implementation of the first embodiment of the invention;

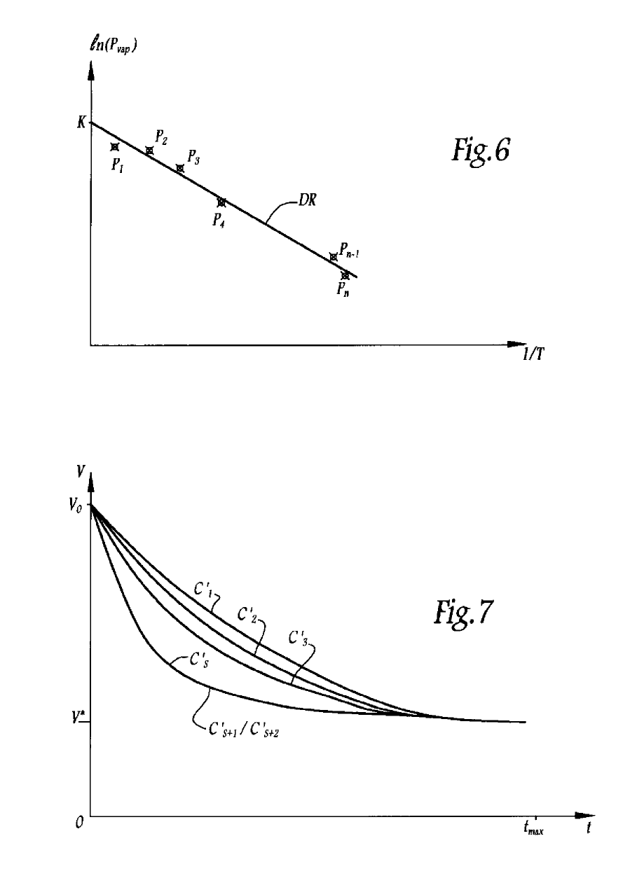

FIG. 6 is a graph, illustrating the steam pressure variation as a function of the temperature, drawn during the implementation of another embodiment of the invention;

FIG. 7 is a graph, illustrating the variation of the bubble volume as a function of their residence time, during implementation of an additional embodiment of the invention;

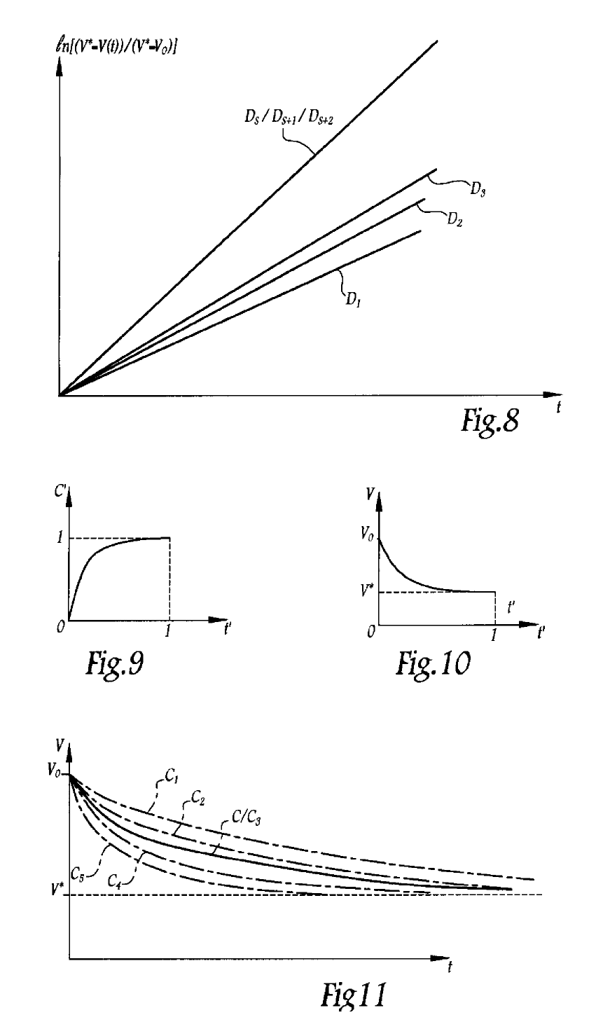

FIG. 8 is a graph obtained from that of FIG. 7;

FIGS. 9 to 11 are additional graphs, drawn during the implementation of still another embodiment of the invention;

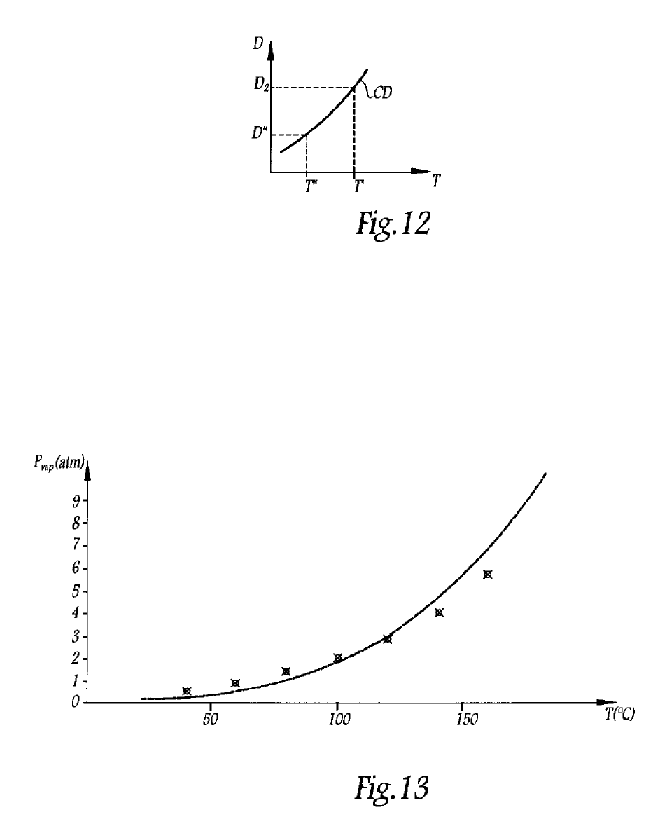

FIG. 12 is a graph, illustrating the diffusion coefficient as a function of the temperature; and

FIG. 13 is an experimental graph illustrating the saturated steam pressure variation as a function of the temperature, for cyclohexane.

The facility according to the invention, in particular illustrated in FIG. 1, first includes liquid supply means. These liquid supply means comprise a source (not shown), placed in communication with a pump 2, of any suitable type, that for example operates using cylinders and that can bear high pressures, for example close to fifty bars. This pump 2 is connected to a downstream so-called supply duct 4.

Furthermore, gas supply means are provided, which include a source 10, from which a duct 12 extends. The flow of the gas is controlled using a mass flow rate controller 14, of a type known in itself. This controller 14 can ensure high-pressure gas flows, up to 50 bars, as well as very low flow rates.

The downstream end of the duct 12 emerges in an intermediate member 16, where it is associated with a pressure sensor 18. This duct 12 is then put in communication with a supply tube 20.

The facility according to the invention also includes bubble generating means, which are more particularly illustrated in FIGS. 2 and 3. These means first include an essentially cylindrical connecting member 22, made from a suitable material, in particular metal or plastic. This connecting member comprises an inner volume V, placed in communication with the outside by three different paths.

To that end, this member is first provided with a channel 24 and a chamber 26, which are coaxial and which have a transverse section respectively smaller and larger than that of the inner volume V. Furthermore, the connecting member 22 is hollowed out by a so-called upper channel 28, provided at the top of FIG. 2. The liquid supply duct 4, described above, is placed in communication with that channel 28.

The connecting member 22 also receives the downstream end 20′ of the supply tube 20. Furthermore, the chamber 26 is provided with a shoulder 26′, against which a flow member 30 abuts, in which the conversion one wishes to study takes place. In this embodiment, this flow member 30 is tubular, i.e. “isolated.” However, alternatively, this flow member can be made up of a channel, etched in a small plate using any suitable method.

We will now provide, as a non-limiting example, values of the equivalent diameter of the intake tube 20 and the flow member 30. “Equivalent diameter” refers to the diameter that the inner walls of said tube and said flow member would have, for a same surface area, if they had a circular section. In the event they are circular, this equivalent diameter of course corresponds to their inner diameter.

The intake tube advantageously has an equivalent diameter between 5 and 50 micrometers. This range is advantageous, inasmuch as it makes it possible to stabilize bubble production. Furthermore, the equivalent diameter of the flow member is between 100 micrometers and several centimeters, for example close to 600 micrometers.

This flow member 30 is, for example, made from silica glass. However, it can be made from other materials, for example plastic or metal. It will be noted that the nature of the selected material must be appropriate, as a function of the selected detection mode. Thus, in the case where the flow member is associated with optical detection, it will advantageously be chosen to be transparent.

The flow member extends in an enclosure 32, which is filled with a fluid, such as an oil, in communication with a thermostat bath 34. This consequently makes it possible to work under conditions that can be considered isothermal.

Opposite the flow member, a rapid camera 38 is provided, in particular of the CCD type. Advantageously, such a camera can acquire a large number of images, for example more than 2000 images/second, in particular more than 10,000 images per second. This camera is associated with a light source 40, placed across from said camera, on the other side of the flow member and its enclosure.

At its downstream end, the flow member 30 emerges in a reservoir 42, which is connected with a pressure gauge 44. The latter part thus makes it possible to set the pressure at which the different flows will occur.

Lastly, a control unit 50 of the computer is provided. This unit controls the various mechanical members described above, i.e. the pump, the flow rate gauge, the camera, the bath, and the pressure gauge. This control unit receives information from the pressure sensor, as well as a temperature sensor 52, capable of measuring the temperature within the enclosure.

The implementation of the facility, described above in reference to FIGS. 1 and 2, will now be explained below.

During use, as illustrated in FIG. 3, the supply tube 20, which is centered and guided in the channel 24, is pushed in until it protrudes past the shoulder 18′. In other words, the walls opposite the flow member 30 and the tube 20 form an overlap area, denoted R, that extends immediately downstream, i.e. to the right of the shoulder 18′ in FIG. 3.

According to the invention, it is desirable to predetermine at least one parameter of a conversion using a transfer between the liquid and gas phases, which may take place in the flow member 30. To that end, the liquid L and gas G phases are circulated in the duct 4 and the supply tube 20, respectively. The typical injection rate is for example between 100 μL/h and 100 mL/h for the liquid phase, and between 0.1 nmL/min and 50 nmL/min for the gas phase. In the present description, the letter “n” used as a prefix relates to a “normal” volume in the normal sense for the gas phase volumes.

Immediately downstream of the overlap area R, the two phases are put in contact with one another in a so-called contact zone, denoted C. Given that these two phases are heterogeneous, gas bubbles B are formed within the liquid L, which constitutes the carrier phase.

Typically, the liquid phase has an affinity, in light of the walls of the flow member, which is greater than that of the gas phase. Under these conditions, this explains the formation of the gas bubbles, which do not extend as far as said walls. However, it is possible to use liquid and gas phases such that they form a segmented flow. The latter assumes the form of a series of bubbles and drops, forming globally cylindrical alternating sections.

The different bubbles B, as well as the liquid carrier phase L, flow in the flow member, while being the site of the conversion one wishes to study. Thus, during the progression of the bubbles and the carrier phase, this conversion takes place, using at least one transfer between the liquid and gas phases. Furthermore, as mentioned above, this transfer can be accompanied by at least one other phenomenon, in particular of a reactive nature.

Furthermore, for a constant flow rate of supplied gas and liquid phases, there is an equivalency between space and time. In other words, a point situated at a given distance from the overlap area R corresponds to a constant residence time of the bubbles and carrier phase.

That being specified, in a first embodiment, the solubility of the component making up the gas phase in the component making up the liquid phase is determined according to the invention. As the bubbles progress in the flow member, the size thereof tends to decrease, due to the transfer of the gas phase toward the liquid phase. In other words, the gas tends to dissolve in the liquid.

In a first so-called transitional phase, the size of the bubbles decreases continuously. Then, when this transfer reaches an equilibrium phase, two cases can be considered. First, it is possible for the gas bubbles still to be present in the liquid. In that case, the size of those bubbles no longer decreases, even when the bubbles and the liquid continue to flow in the flow member. On the other hand, in the case where all of the gas is dissolved in the liquid, there are no more gas bubbles in the equilibrium state.

According to a first alternative of the invention, a given gas flow rate QG and liquid flow rate QL(1) are set, for which all of the gas is not dissolved in the equilibrium state. In other words, for this initial flow rate pair, gas bubbles remain in the liquid, in the equilibrium state. One condition of the flow, i.e. the ratio between the liquid and gas flow rates, is then modified.

Thus, while keeping the gas flow rate at a constant value, an additional experiment is done for a higher liquid flow rate, denoted QL(2). This operation is reiterated, with increasing successive flow rates QL(3), QL (4), . . . , QL(n). The liquid flow rate threshold value QL(s) is then noted, for which the bubbles completely disappear, in the equilibrium state. In other words, below this threshold value, bubbles still remain in the equilibrium state, whereas, at that threshold value and at higher values, no more bubbles remain in the liquid.

FIG. 4 illustrates a first experimental scenario. In this figure, we see the evolution of the volume V of the bubbles B, identified by the camera, as a function of the length l, i.e. the position of the liquid and gas phases along the member 30. In other words, a length l=0 corresponds to the point of formation of the bubbles, while a length l=L corresponds to the other end, placed on the right of FIG. 1, of the observation zone of the flow member by the camera. As seen above, the length l is connected to the residence time t of the bubbles and the liquid in the flow member.

In this FIG. 4, C₁, C₂ and C₃ denote the first three curves obtained, for the first three liquid flow rates QL(1), QL(2) and QL(3). For each of these curves, the volume of the bubbles decreases, then stabilizes to become constant. Thus, for each of these flow rate values, in the equilibrium state corresponding to zones ZE₁ to ZE₃, the gas bubbles are still present.

Then, C(S−1) denotes the curve corresponding to the flow rate QL(S−1), immediately below the threshold flow rate QL(S). On this curve, the volume of the bubbles decreases more significantly than on the first three curves above, but reaches an equilibrium value strictly greater than 0, i.e. bubbles are still present in an equilibrium zone ZE(S−1). On the other hand, for the threshold flow rate value, the curve C(S) has a first transitional zone ZT(S), for which the volume of the bubbles decreases continuously, then a second zone ZE(S), for which there are no more bubbles in the liquid zone. In other words, all of the gas initially present in the bubbles is dissolved in the liquid phase.

As shown above, in FIG. 4, the equilibrium zone ZE(S) is located in the viewing field of the camera. However, in other situations, for which the transfer is slower, this equilibrium zone can be located outside said viewing field. In other words, the camera then views only the transitional phase of the transfer.

Thus, in reference to FIG. 5, for the flow rate QL(S−1), immediately below the threshold flow rate, the volume of the bubbles stabilizes on the right part of the curve C(S−1), i.e. it can be considered that one is in the equilibrium zone ZE(S−1) of said transfer. On the other hand, for the threshold value QL(S), even when bubbles still remain at the right end of the curve C(S), the latter is not stabilized, i.e. it continues to decrease.

In other words, it can be considered that the equilibrium zone Z(S) is situated to the right of the end of the tube 30. Thus, this curve will extend, until it joins the X axis, which corresponds to a total dissolution of the gas. This extrapolation is illustrated by dotted lines in said FIG. 5.

In the preceding, the threshold flow rate QL(S) has been determined using the camera. However, this identification of the threshold flow rate can be done differently. To that end, it should be ensured that the transfer is in fact located in its equilibrium zone, at the downstream end of the flow tube.

Under these conditions, the determination can be done visually by the operator, at said downstream end of the flow member. In that case, as the flow rate increases, said operator verifies whether gas bubbles remain at said downstream end. The threshold flow rate is then the first flow rate, from which all of the bubbles have disappeared at that end.

A laser emitter can also be used, placed on a first side of the downstream end of the tube, which is associated with a photodiode, placed opposite said emitter. At the downstream end of the flow tube, the signal emitted by the photodiode is then observed as a function of time, for example according to the teaching of FR-A-2 929 403. In that case, the threshold flow rate corresponds to the flow rate from which the signal emitted by the photodiode stabilizes at a single value that is representative of the formation of a liquid flow, the bubbles of which are henceforth absent. It is also possible to use any other suitable sensor, for example an ultrasound sensor.

Once the liquid threshold flow rate has been determined, the value of a first parameter of the transfer, i.e. the solubility limit, is deduced therefrom, using the following equation:

$${S}^{*} ( P , T ) = \frac{QGm}{QGm + QLm ( S )} \qquad ( 1 )$$

where QGm is the fixed gas molar flow rate and QLm(S) is the threshold liquid molar flow rate, as determined above. It is then possible to determine another parameter, i.e. the constant k of Henry's law. The quantity of gas dissolved in a liquid, in the event the latter is a solute, is proportional to the partial pressure exerted by the gas on the liquid. The expression of the Henry's constant is as follows:

$$k ( T ) = \frac{{S}^{*} ( P , T )}{P - {P}_{vap}} \qquad ( 2 )$$

where k(T) is the Henry's constant as a function of the temperature, S*(P, T) is the value of the solubility limit determined above, P is the pressure set using the gauge 44, and Pᵥₐₚ is the steam pressure of the studied liquid. It is also possible, owing to the invention, to calculate the steam pressure of a liquid. This makes it possible, among other things, to access the Henry's constant using the above equation, even if the liquid being studied is unknown.

More specifically, this steam pressure is calculated by obtaining two solubility curves at different pressures. It is in fact known that the Henry's coefficient does not depend on the pressure, but the temperature. Thus, for a given temperature T, the Henry's constant k is invariable, at two different pressures denoted P₁ and P₂. This therefore yields:

$$k ( {P}_{1} ) = k ( {P}_{2} ) , i . e . \\ \frac{{S}^{*} ( {P}_{1} , T )}{{P}_{1} - {P}_{vap}} = \frac{{S}^{*} ( {P}_{2} , T )}{{P}_{2} - {P}_{vap}} \qquad ( 3 )$$

An additional parameter, i.e. the steam pressure of the liquid, can therefore be deduced at the temperature T, using the expression:

$${P}_{vap} ( T ) = \frac{S * ( {P}_{2} , T ) \times {P}_{1} - {S}^{*} ( {P}_{1} , T ) \times {P}_{2}}{{S}^{*} ( {P}_{2} , T ) - {S}^{*} ( {P}_{1} , T )} \qquad ( 4 )$$

where S*(P₁, T) and S*(P₂, T) are the two solubility limit values, for the same temperature T and for the respective pressures P₁ and P₂.

Another parameter can also be deduced, i.e. the latent vaporization heat of the liquid, denoted L, from the Clausius-Clapeyron relationship:

$$\frac{d {P}_{vap}}{d T} = \frac{L}{T ( Δ V )} ,$$

where Pᵥₐₚ is the steam pressure, T is the temperature, and ΔV corresponds to the volume increase due to the change of state, i.e. the vaporization.

Using the perfect gas equation, and integrating the temperature between a reference temperature and T, the following equation is obtained:

$$ln {P}_{vap} ( T ) = K - \frac{L}{R} ( \frac{1}{T} ) ,$$

where K is a constant related to the chosen reference and R is the constant of the perfect gas equation.

Equation (4) above makes it possible to access each of the experimental values P1 to Pn as a function of T1 to Tn. In(Pᵥₐₚ) is next drawn as a function of 1/T, according to the curve in the appended FIG. 6. From these different points, a regression line DR is drawn, the ordinate of which at the origin corresponds to the constant K above and the slope of which corresponds to −L/R. The value of this ratio −L/R is then deduced and then, because R is a constant, the value of the latent vaporization heat L is deduced.

In the preceding, the equilibrium phase of the transfer between the gas and the liquid was studied, which makes it possible to access thermodynamic parameters. Henceforth, in the following, we will study the transitional phase of this transfer, which will make it possible to access other types of parameters, in particular kinetic ones. In the first embodiment of the invention, described above, the liquid flow rate is increased for a fixed gas flow rate, which amounts to gradually increasing the ratio between the liquid and gas flow rates, respectively. Henceforth, this ratio is fixed at a constant, then a parameter of the flow is varied, i.e. the value of each of these flow rates is increased.

More specifically, a ratio is advantageously chosen such that, at the downstream end of the flow tube, bubbles are still present in the liquid. Then, the values of the flow rates are increased, at a constant ratio, and the volume of the bubbles is identified along the flow member. This makes it possible to access different curves, similar to those of the preceding figures, in which the volume of the bubbles V decreases as a function of their residence time t in the flow member.

FIG. 7 illustrates the different curves C′₁ to C′ₛ, obtained using the method described above, for a residence time between 0, i.e. the injection moment of the bubble, and tₘₐₓ, which corresponds to the residence time at the downstream end of the viewing area by the camera. It can be seen that, for all of these curves, one starts from a same initial volume V₀, which corresponds to the volume of the bubbles in their injection zone, immediately downstream of the overlap zone R. It will also be noted that the final volume V* of these bubbles is identical, irrespective of the values of the flow rates. This value V* corresponds to a volume of the bubbles in the equilibrium state.

We will now look at the transitional zone ZT, i.e. that for which the volume of the bubbles decreases continuously. It will be noted that, at least as regards the first curves C₁ to C_{S}, the latter have different profiles, connecting the initial value V₀ and the final value V*. On the other hand, the higher the flow rate, the more the volume of the bubbles tends to decrease quickly. In other words, the slope of these curves is increasingly significant as the flow rate increases, or in other words, the higher the flow rate, the lower the curve in FIG. 7.

Then, if the flow rate is still further increased, beyond the flow rate Q's corresponding to the curve C's above, it will be noted that the following curves C′_{S+1}, C′_{S+2} . . . are combined with the curve C's. Beyond that threshold flow rate Q's, still called limit flow rate, the curves are superimposed. Without wishing to be bound by the theory, when the flow rate is above that threshold value, the speed of the flow no longer influences the solubilization speed. It is then limited by the diffusion.

In other words, for a flow rate value below the limit, the speed affects the transfer and the diffusion phenomenon is not limiting. On the other hand, once the flow rate is above the limit value, the speed no longer has an impact on the solubilization speed, and the latter is limited by the diffusion in the liquid phase.

The study of the transitional phase, as explained above, in particular makes it possible to determine the mass transfer coefficient. The latter, denoted kla, corresponds to the quantity of gas exchanged per unit of volume. This is a global volumetric coefficient, which is made up of the member kl corresponding to the global mass transfer coefficient relative to the liquid phase, and the member a, which corresponds to the interfacial exchange area. This coefficient is expressed in s⁻¹.

The transfer that occurs between the gas and liquid phases can be calculated using Fick's law, one of the forms of which can be written as follows:

$$- \frac{d C ( t )}{d t} = kla ( {C}^{*} - C ( t ) )$$

By integrating between 0 and t, the following equation is obtained:

$$ln ( \frac{{C}^{*} - C ( t )}{{C}^{*} - {C}_{0}} ) = {k}_{l} a ( t - {t}_{0} ) \qquad ( 5 )$$

where kla is the mass transfer coefficient, C* is the gas concentration in the liquid at saturation, C(t) is the average concentration in the liquid at time t, and C₀ is the average initial concentration in the liquid. At the initial time t=0, the gas is in the bubble, then it is gradually transferred into the liquid. The gas concentration in the liquid phase then increases. This concentration is directly related to the transferred volume of gas and, as a result, the volume lost by the bubble. Under these conditions, the preceding equation can be transformed as follows:

$$- ln ( \frac{{V}^{*} - {V}_{0}}{{V}^{*} - {V}_{( t )}} ) = {k}_{l} a ( t - {t}_{0} ) , \qquad ( 6 )$$

where V* corresponds to the equilibrium volume, i.e. the volume of the bubble when the liquid is saturated with gas, V(t) corresponds to the volume of the bubble at time t, and V₀ corresponds to the initial volume of the bubble, i.e. at its area of formation. This equation makes it possible to access a value of the transfer parameter, i.e. the mass transfer coefficient, without varying the flow conditions.

From this equation, we will now determine different values of the mass transfer coefficient kla, for flows that take place at a same temperature, for a same ratio between the liquid and gas flow rates. However, one condition of the flow, i.e. the flow rate of each of said phases, is varied over the course of the different experiments.

More specifically, the expression ln

$$( \frac{{V}^{*} - {V}_{0}}{{V}^{*} - V ( t )} )$$

is drawn as a function of time t. Space and time being connected within the flow member, the measurements of the volume of the bubbles, in different positions l along said member, correspond to respective residence times t.

FIG. 8 shows the results of these experiments. For each of the measurements, a linear regression line is drawn that corresponds to the cloud of experimental points obtained.

A series of lines is thus obtained, denoted D₁ to D₃ then D_{S}, that correspond to flow rates Q₁ to Q₃ then Q_{S}, which are increasingly high points. Then, if one still further increases the flow rate beyond the value Q_{S}, the following experimental curves D_{(S+1)}, D_{(S+2)}, . . . are substantially combined with the line D_{S}. This is the phenomenon described above in reference to FIG. 7 in a different form. Thus, when the flow rate is higher than Q_{S}, the speed of the flow no longer influences the solubilization speed, which explains why the subsequent curves, at higher flow rates, are combined with Ds.

From the different experimental curves obtained above, the value of kla is obtained, which corresponds to the slope of the lines D₁ to D_{S}. It is consequently deduced that, before the threshold flow rate value Q_{S}, the coefficient kla increases continuously with the flow rate. Then, from this threshold flow rate value, this transfer coefficient is substantially invariable.

It is advantageous to know this flow rate threshold value, since for any higher flow rate, the conditions are identical in terms of mass transfer, for a given temperature. It will be recalled that the overall kinetics include a transfer kinetics term, as well as a conversion kinetics term. Under these conditions, if the transfer kinetics are invariable, for a range of flow rate values, other types of kinetic data can be accessed. Furthermore, being able to work with different flow rates without modifying the transfer kinetics makes it possible to vary the residence time without influencing the mass transfer.

In the preceding, we have first tried to determine a thermodynamic parameter by studying the equilibrium zone ZE, then a kinetic parameter by studying the transitional zone ZT. In the following, we will now try to determine a thermodynamic parameter, in this case the diffusion coefficient D of the gas in the liquid, by studying the transitional area ZT.

To that end, a physical model must first be established, using this diffusion coefficient D as the sole variable. Without wishing to be bound by the theory, it can be stated that the transfer that occurs in a flow is made up of two mechanisms, i.e. diffusion and convection, which is illustrated by the creation of recirculation loops.

Three sizes can then be considered, which can be used as bases to determine limit flow conditions. This first involves the diffusion time, which corresponds to the ratio between the square of the radius of the capillary and the diffusion coefficient; the convection or recirculation time, which corresponds to the ratio between the distance between two bubbles and the flow speed; and lastly, the Péclet number, defined by the ratio between the diffusion time and the recirculation time.

This embodiment uses an approximation for the calculation, i.e. it is considered that the hemispheres of the pockets are flat, i.e. the gas bubbles have a cylindrical shape. In the borderline case where the recirculation time is much shorter than the diffusion time, there is a situation in which, at the initial time, the recirculation loops are completely saturated with gas. The transfer is then independent of the speed and one works at flow rates higher than the limit flow rate, as identified above. The diffusion is done from the cells generated by the recirculation.

In the case described above, the Péclet number is high. The concentration on the recirculation loops corresponds to those of the gas saturated in the liquid. It is considered that the concentration in the gas phase, at the initial time, is approximately zero.

In order to calculate the mass transfers by diffusion, illustrating the diffusion in the case where the recirculation time is much shorter than the diffusion time, it is for example possible to use a method by finite elements, purely non-limitingly. More specifically, R denotes the radius of the flow member, and Z the length of the liquid cell. The latter, which is deduced from the volume fraction of gas and the initial volume of the bubble, corresponds to the distance between two bubbles. Adimensional variables are used, i.e. t′ and C′, where

$${t}^{′} = t \cdot \frac{D}{{R}^{2}} and {C}^{′} = \frac{C}{{C}^{*}} ,$$

where

t corresponds to the time, D corresponds to the diffusion coefficient, R to the above radius, C to the average concentration in the liquid, and C′ to the gas saturation concentration in the liquid.

The curve illustrating the variations of C′ as a function of t′ is shown in FIG. 9. Furthermore, the number of moles lost by the gas bubble as a function of time is equal to:

n=C′·C*Vliq, where

V_{liq}=π·R²·Z.

Under these conditions, by performing an approximation of the perfect gas type, it is possible to write the following equation:

$${V}_{perdu} = \frac{n \cdot {R}_{GP} \cdot T}{P} = \frac{{C}^{′} \cdot {C}^{*} \cdot {V}_{liq} \cdot {R}_{GP} \cdot T}{P} ,$$

where

V_{perdu} corresponds to the volume of gas lost as a function of time, i.e. diffused from the bubble toward the liquid phase, R_{GP} corresponds to the constant of the perfect gases, T corresponds to the temperature, and P corresponds to the pressure.

The volume of the bubble as a function of time is then written V=V₀−V_{perdu}. The corresponding curve, as a function of the adimensional time, is illustrated in FIG. 10.

As shown above, the adimensional time is a function of the real time, a constant corresponding to the square of the radius of the flow member, and the diffusion coefficient D. Under these conditions, this coefficient D, which is an unknown, can be considered a variable connecting the real time and the adimensional time. In other words, it is possible to go from the curve of FIG. 10, illustrating the variation of V as a function of the adimensional time t′, to several curves illustrating the variation of the volume V as a function of the real time t, by varying the value of the coefficient D.

Under these conditions, the actual value of the diffusion coefficient D can be identified, by comparing different theoretical curves with a real curve established experimentally. This is illustrated in FIG. 11, where one first sees an experimental curve C, illustrating the variation of the volume V as a function of the residence time t, for example obtained using the camera. Five curves C₁ to C₅, corresponding to five values D₁ to D₅ of the diffusion coefficient, are also shown in mixed lines, illustrating the variation of the volume V no longer as a function of the adimensional time t′, but now of the residence time.

It is then possible to adjust the value of the variable D in the theoretical model so that one of the theoretical curves corresponds to the experimental curve. This makes it possible to deduce the actual value of D, according to the invention. In the case of FIG. 11, the theoretical diffusion values D₁, D₂ as well as D₄ and D₅ are not accurate, since the curves C₁ C₂ C₄ and C₅ are far from the experimental curve C. On the other hand, the value of D₃ makes the theoretical curve C₃ correspond to the real curve C. Under these conditions, the value D₃ used for the theoretical model is chosen as the predetermined value of the diffusion coefficient D.

Advantageously, gas bubbles are formed whereof the initial volume is significant, so as to preserve recirculations along the flow of the liquid and gas phases, respectively, as much as possible. Under these conditions, the volume of the bubble decreases slightly as a function of its residence time. As a non-limiting value, the initial equivalent diameter of each bubble, when it is formed, is larger than 90%, in particular 110%, of the equivalent diameter of the flow member.

From the diffusion value D, determined according to the steps described above for a given temperature, it is possible to deduce the value of this diffusion coefficient for other temperatures. This makes it possible to achieve, experimentally, the variation D(T) of this coefficient as a function of the temperature.

From there, it is possible to access the value of at least one additional parameter. Thus, first, if the evolution law of the viscosity with the temperature is known, the Stokes-Einstein law can be used to access the hydrodynamic radius of the gas molecule. The Stokes-Einstein law is as follows:

$$D = \frac{kT}{6 η π R} ,$$

where

D is the diffusion coefficient, k is the Boltzmann's constant, T is the temperature, η is the viscosity of the component of the liquid phase, and r is the hydrodynamic radius of the molecule of the component of the gas phase.

Among the above values, k and r do not vary as a function of the temperature, and it is assumed that the variation of the viscosity has been determined as a function of this temperature from existing laws and experimental data.

FIG. 12 illustrates the experimental curve mentioned above, grouping together the different values of the diffusion coefficient D from the value T. From the different experimental points, the curve CD is taken, from which one can take the value of the diffusion coefficient for any chosen temperature, which was not subject to an experimental measurement. Thus, in this FIG. 12, it is for example possible to extrapolate a value D″ for the temperature T″.

Furthermore, using the Stokes-Einstein law, this curve CD makes it possible to access the value of the hydrodynamic radius r.

Alternatively, one may consider a case where the hydrodynamic radius of the molecule is known, but not the viscosity. In that case, knowing the variation of the diffusion coefficient as a function of the temperature makes it possible to access the variation of the viscosity as a function of the temperature.

The invention makes it possible to achieve the aforementioned aims.

In fact, it first makes it possible to simply determine at least one parameter of a conversion using a liquid-gas transfer, by using components that are not complex and that are therefore relatively inexpensive.

Furthermore, owing to the invention, it is possible to vary the conditions under which the gas and liquid flow very simply. In this respect, the flow rate of each phase, the ratio between those flow rates, or the pressure and temperature can be modified quickly.

It should also be stressed that the invention makes it possible to use very small volumes of the physicochemical system it aims to study. This is advantageous on the one hand for highly exothermic reactions, inasmuch as it eliminates any risk of significant explosion.

On the other hand, bringing small volumes into play is particularly important, in the case of a physicochemical system with a high price or toxicity.

We will now, purely non-limitingly, present various examples of embodiments of the invention.

### EXAMPLE 1

This example illustrates the study of the solubility of pure oxygen in cyclohexane. To that end, a given oxygen flow rate is set and the cyclohexane flow rate is gradually increased, using the procedure described in reference to FIG. 4. The Henry's coefficient is then determined at 20° C., for different oxygen flow rates and different pressures. The corresponding results are shown in the table below.

| P (bar) | Qg (mL/h) | Ql (mL/h) | k(T) (1/bar) |
|---|---|---|---|
| 25.1 | 0.47 | 1.8 | 1.12E−03 |
| 25.1 | 0.94 | 4.1 | 9.85E−04 |
| 25.3 | 1.89 | 8.3 | 9.77E−04 |
| 30.2 | 0.98 | 4 | 1.05E−03 |
| 30.4 | 2.34 | 10.1 | 9.94E−04 |
| 20.2 | 1.18 | 4.3 | 1.18E−03 |
| 20.6 | 3.46 | 14.8 | 1.01E−03 |
| 13.2 | 1.79 | 8.5 | 9.19E−04 |
| 13.5 | 5.17 | 26.7 | 8.45E−04 |

From the various experimental values above, an arithmetical average value of 1,015.10⁻³ bar⁻¹ is deduced. This experimental value has a good level of coherence with the value from the literature, which is 1,15.10⁻³ bar⁻¹.

### EXAMPLE 2

This example aims to determine the variation of the saturating steam pressure of the cyclohexane, as a function of the temperature. To that end, equation (4) stated above is used. Different experimental values are shown in FIG. 13, attached.

### EXAMPLE 3

This example relates to the determination of the latent vaporization heat of cyclohexane. To that end, equation (4′) above is used. More specifically, the variation of the logarithm of the steam pressure of the cyclohexane is drawn, as a function of the inverse of the temperature.

The slope of the regression line thus obtained, as illustrated in FIG. 6, makes it possible to access the vaporization heat of that cyclohexane. Experimentally, we find L=23 kJ/mol, which has a satisfactory level of coherence with the Handbook value of 29.9 kJ/mol.

### EXAMPLE 4

This example relates to the determination of the mass transfer coefficient, relative to the pure oxygen and cyclohexane pair.

To that end, the steps described in reference to FIGS. 7 and 8 are followed, at ambient temperature and for an oxygen volume fraction of 20%. It can be seen that the transfer coefficient increases with the imposed flow rate, until it reaches a maximum value equal to 0.40 s⁻¹. The threshold flow rate, as defined above, is close to 3 mL/h of cyclohexane.

### EXAMPLE 5

This example relates to the determination of different values of the diffusion coefficient of oxygen in cyclohexane. To that end, several series of experiments are conducted, according to the procedure described in reference to FIG. 11. The pressure is 26 bars, the cyclohexane flow rate is 8 mL/h, and the oxygen flow rate is 4.8 mL/h.

The corresponding results are shown in the table below.

| T (° C.) | D (m²/s) | C* (mol/L) | V0 (mm³) |
|---|---|---|---|
| 57.1 | 6.8E09 | 0.23 | 0.067 |
| 57.2 | 6.8E09 | 0.235 | 0.064 |
| 47 | 5.5E09 | 0.18 | 0.074 |
| 49 | 5.5E09 | 0.29 | 0.079 |
| 36 | 4.5E09 | 0.32. | 0.077 |
| 36 | 4.5E09 | 0.29 | 0.075 |
| 31 | 3.9E09 | 0.36 | 0.093 |
| 31 | 3.9E09 | 0.36 | 0.094 |
| 31 | 3.9E09 | 0.34 | 0.0909 |
| 31 | 3.9E09 | 0.3 | 0.092 |
| 31 | 3.9E09 | 0.3 | 0.088 |
| 77 | 7.7E09 | 0.28 | 0.0738 |

In order to verify the coherence of the above results, the variation of kT/6ηπ is drawn as a function of the diffusion coefficient, so as to experimentally obtain the hydrodynamic radius of the oxygen. To that end, the following law of the viscosity of the cyclohexane is used:

$$ln ( η ) = - 69 , 3140 + \frac{4086 , 2}{T} + 8 , 5254 \times ln ( T ) \qquad ( 16 )$$

The points thus obtained are then connected using a regression line, the slope of which makes it possible to access the hydrodynamic radius. The experimental value is equal to 7.10⁻¹¹ m, which should be compared with half of the oxygen-oxygen bond value of the dixoygen value (12.10⁻¹¹ m).

1-27. (canceled)

28. A method, using transfer between a gas phase and a liquid phase, for predetermining at least one conversion parameter comprising:
injecting a gas phase into a liquid phase to form a heterogeneous flow comprising a series of bubbles of the gas phase in the liquid phase,
flowing said heterogeneous flow within a flow member while at least one transfer occurs between the gas phase and the liquid phase,
measuring a decrease in a volume of the bubbles flowing along said flow member, and
determining said at least one conversion parameter from the measured decrease in volume.

29. The method of claim 28, further comprising varying a value of at least one condition of said flow.

30. The method of claim 29, wherein the value comprises a ratio of a flow rate of the liquid phase to a flow rate of the gas phase.

31. The method of claim 30, wherein the gas flow rate is fixed and the flow rate of the liquid phase is increased.

32. The method of claim 31, wherein measuring a decrease in a volume of the bubbles flowing along said flow member comprises determining a threshold liquid molar flow rate, in an equilibrium state of the transfer, where no bubbles are present in the liquid phase,
wherein the at least one conversion parameter is determined from the threshold liquid molar flow rate.

33. The method of claim 32, wherein determining the at least one conversion parameter comprises determining a solubility limit from the threshold molar flow rate by the equation:
$${S}^{*} ( P , T ) = \frac{QGm}{QGm + QLm ( S )}$$
wherein QGm is a fixed gas molar flow rate and QLm(S) is the threshold liquid molar flow rate.

34. The method of claim 33, wherein determining the at least one conversion parameter further comprises determining Henry's constant from the solubility limit by the following equation:
$$k ( T ) = \frac{{S}^{*} ( P , T )}{P - {P}_{vap}}$$
wherein k(T) is the Henry's constant as a function of temperature, S*(P, T) is the solubility limit, P is a flow pressure, and Pᵥₐₚ is a steam pressure of the liquid phase.

35. The method of claim 34, wherein determining the at least one conversion parameter further comprises determining at least two solubility limit values at least at two different pressures, and determining a steam pressure of the liquid phase by the equation:
$${P}_{vap} ( T ) = \frac{{S}^{*} ( {P}_{2} , T ) \times {P}_{1} - {S}^{*} ( {P}_{1} , T ) \times {P}_{2}}{{S}^{*} ( {P}_{2} , T ) - {S}^{*} ( {P}_{1} , T )} \qquad ( 4 )$$
wherein S*(P₁, T) and S*(P₂, T) are the two solubility limit values for the same temperature T and for the two respective pressures P₁ and P₂.

36. The method of claim 35, wherein determining the at least one conversion parameter further comprises determining values of the vaporization pressure as a function of the temperature, and determining a vaporization latent heat by the following equation:
$$ln {P}_{vap} ( T ) = K - \frac{L}{R} ( \frac{1}{T} ) ,$$
wherein L is the vaporization latent heat, T is the temperature, and K and R are constants.

37. The method of claim 28, wherein determining the at least one conversion parameter comprises determining the at least one conversion parameter without modifying a condition of the flow.

38. The method of claim 37, wherein determining the at least one conversion parameter further comprises determining a mass transfer coefficient by the following equation:
$$- ln ( \frac{{V}^{*} - {V}_{0}}{{V}^{*} - {V}_{( t )}} ) = {k}_{l} a ( t - {t}_{0} ) ,$$
wherein V* represents an equilibrium volume, V(t) represents a volume of a bubble at time t, and V₀ represents an initial volume of the bubble.

39. The method of claim 28, further comprising varying a value of at least one condition of the flow and determining conversion parameters for different values of the at least one condition.

40. The method of claim 39, further comprising holding a ratio of a liquid phase flow rate to a gas phase flow rate constant, varying each flow rate, and determining a mass transfer coefficient for each flow rate.

41. The method of claim 40, further comprising identifying a threshold flow rate from which the mass transfer coefficient is substantially invariable.

42. The method of claim 37, wherein determining said at least one conversion parameter from the measured decrease in volume comprises:
defining a mathematical model relating the volume of the bubbles to a residence time of the heterogeneous flow in the flow member,
wherein the conversion parameter to be determined is a sole variable,
modeling the decrease of the volume of the bubbles as a function of residence time (t) in the flow member,
adjusting the conversion parameter such that the decrease of a modeled volume and the decrease of the measured volume are identical, and
identifying a value of the conversion parameter resulting in the identical volumes.

43. The method of claim 42, wherein the parameter comprises a diffusion coefficient (D).

44. The method of claim 43, further comprising defining an adimensional time (t′) proportional to the residence time (t) according to a proportionality coefficient based on the diffusion coefficient (D).

45. The method of claim 28, wherein injecting the gas phase into the liquid phase comprises flowing the gas phase in an inner supply member to form bubbles,
wherein the inner supply member comprises an overlap area with the flow member, and
further wherein the equivalent diameter of the inner supply member ranges from 5 to 50 micrometers.

46. The method of claim 45, wherein the equivalent diameter of the flow member ranges from 100 micrometers to 5 cm.

47. The method of claim 46, wherein the equivalent diameter of the flow member is about 600 micrometers.

48. The method of claim 28, wherein injecting the gas phase into the liquid phase comprises injecting the gas phase at a gas flow ranging from 0.001 nmL/min to 1 nL/min.

49. The method of claim 48, wherein the gas flow rate ranges from 0.1 nmL/min to 10 nmL/min.

50. The method of claim 28, wherein the heterogeneous flow is flowed at a flow rate ranging from 0.001 mL/h to 10 L/h.

51. The method of claim 50, wherein the flow rate ranges from 0.1 mL/h to 100 mL/h.

52. The method of claim 28, wherein measuring the decrease in the volume of the bubbles comprises observing the bubbles with a camera.

53. The method of claim 28, wherein the decrease in bubble volume comprises detecting, in the equilibrium state of the transfer between the liquid phase and the gas phase, the presence of residual bubbles at a downstream end of the flow member.

54. A device comprising:
a liquid phase supply component comprising a liquid phase;
a gas phase supply component comprising a gas phase;
an injection component adapted to injecting the gas phase from the gas phase supply component into the liquid phase from the liquid phase supply component to form a heterogeneous flow comprising a series of bubbles of the gas phase in the liquid phase;
a flow member in communication with the injection component and adapted to flow the heterogeneous flow;
an observation component adapted to observe a decrease in a volume of the bubbles along the flow member; and
a component adapted to determine at least one parameter connected with the observation component.
